(19) United States
(12) Patent Application Publication
(10) Pub. No.: US 2026/0242177 A1
(43) Pub. Date: Aug. 20, 2026

(54) METHOD AND A SYSTEM FOR DETERMINING A FILL LEVEL OF AN ELEVATOR CAR

(71) Applicant: KONE Corporation, Helsinki (FI)

(72) Inventors: Qiang SUN, Suzhou (CN); Mika KEMPPAINEN, Helsinki (FI); Yong Qing LU, Suzhou (CN); Pasi RAITOLA, Helsinki (FI); Mari ZAKRZEWSKI, Helsinki (FI); Hannu NOUSU, Helsinki (FI)

(73) Assignee: KONE Corporation, Helsinki (FI)

(21) Appl. No.: 19/646,726

(22) Filed: Apr. 14, 2026

Related U.S. Application Data
(63) Continuation of application No. PCT/CN2023/130470, filed on Nov. 8, 2023.

(51) Int. Cl. B66B 1/34; B66B 1/24; G06V 10/764; G06V 10/82; G06V 20/52

(52) U.S. Cl. CPC B66B 1/3476; B66B 1/2408; G06V 10/764; G06V 10/82; G06V 20/53

(57) ABSTRACT

A method determines fill level data of an elevator car. The method includes: obtaining image data of the interior of the elevator car; determining the fill level data of the elevator car from the obtained image data by applying a pre-trained fill level classification model; and providing the determined fill level data of the elevator car to an elevator control system for further elevator use. The disclosure relates also to a fill level determination system, an elevator system, a method for training a fill level classification model for determining fill level data of an elevator car, computer programs and computer-readable mediums.

### TECHNICAL FIELD

The invention concerns in general the technical field of elevator systems. Especially the invention concerns fill level of an elevator car.

### BACKGROUND

Fill level of an elevator car of may be used in different operations of an elevator system. The fill level of the elevator car may for example be used in an elevator call allocation. For example, if the elevator fill level indicates that the elevator car is full, further landing calls are not allocated for said elevator car. In other words, the elevator car that is determined to be full based on the determined fill level bypasses the landing(s) between a departure landing and a destination landing, regardless of whether a landing call is generated from the bypassed landing(s).

The fill level of the elevator car may for example be determined by using a weight-based determination. In the weight-based determination, the fill level of the elevator car may be determined based on weight data provided by a weighing system of the elevator car. The weight-based determination may be inaccurate because of non-human objects, e.g. luggage, wheelchair and/or goods, inside the elevator car. Thus, the weight-based determination may cause incorrect determination of the fill level of the elevator car, which in turn may lead to unnecessary stops of the elevator car at landings, although there is no room for new passengers inside the elevator car.

Alternatively, the fill level of the elevator car may be determined by using image analysis-based determination. In the image analysis-based determination, the fill level of the elevator car may be determined based on image data provided by an optical imaging device. The image analysis-based determination requires calibration, which is typically done by using one or more baseline images provided by the optical imaging device. The one or more baseline images represent empty elevator car, i.e. the interior of the elevator car being empty. In the image analysis-based determination, the fill level of the elevator car may for example be determined based on an image difference between the one or more baseline images and at least one image of the interior of the elevator car captured by the optical imaging device, when the elevator car is assumed to be filled with passengers and/or non-human objects. The accuracy of the image analysis-based determination may be dependent on the one or more baseline images. For example, if the floor of the elevator car changes (e.g. due to a new carpet, a new floor material, wear of a carpet, wear of a floor material, or fading of color of the floor, etc.), the accuracy of the image analysis-based determination solution may decrease and thus the determination result will be impacted.

Therefore, the is a need to further develop solutions for determining the fill level of the elevator car.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a fill level determination system, a computer program, and a computer-readable medium for determining fill level data of an elevator car, a method, a computer program, and a computer-readable medium for training a fill level classification model for determining fill level data of an elevator car. Another objective of the invention is that the methods, the fill level determination system, the elevator system, the computer programs, and the computer-readable mediums enable providing an image analysis-based elevator car fill level determination solution without a need for a calibration.

The objectives of the invention are reached by methods, a fill level determination system, an elevator system, computer programs, and computer-readable mediums as defined by the respective independent claims.

According to a first aspect, a method for determining fill level data of an elevator car is provided, wherein the method comprises: obtaining image data of the interior of the elevator car; determining the fill level data of the elevator car from the obtained image data by applying a pre-trained fill level classification model; and providing the determined fill level data of the elevator car to an elevator control system for further elevator use.

The determining of the fill level data of the elevator car may comprise determining from the obtained image data by applying the pre-trained fill level classification model a fill level class belonging to a plurality of predetermined fill level classes that corresponds to the fill level of the elevator car in the obtained image data.

The determined fill level data of the elevator car may comprise data indicating the determined fill level class.

The further elevator use may comprise elevator call allocation and/or presentation of information.

The pre-trained fill level classification model may be a convolutional neural network (CNN)-based model.

According to a second aspect, a fill level determination system for determining fill level data of an elevator car is provided, wherein the fill level determination system comprises: an imaging device arranged inside the elevator car and configured to produce image data of the interior of the elevator car, and a computing unit configured to: obtain the image data of the interior of the elevator car from the imaging device; determine the fill level data of the elevator car from the obtained image data by applying a pre-trained fill level classification model; and provide the determined fill level data of the elevator car to an elevator control system for further elevator use.

The determination of the fill level data of the elevator car may comprise that the computing unit may be configured to determine from the obtained image data by applying the pre-trained fill level classification model a fill level class belonging to a plurality of predetermined fill level classes that corresponds to the fill level of the elevator car in the obtained image data.

The determined the fill level data of the elevator car may comprise data indicating the determined fill level class.

The further elevator use may comprise elevator call allocation and/or presentation of information.

The pre-trained fill level classification model may be a convolutional neural network (CNN)-based model.

According to a third aspect, an elevator system is provided, wherein the elevator system comprises: at least one elevator car arranged to travel along a respective elevator shaft, an elevator control system configured to control the operation of the elevator system; and a fill level determination system as described above.

According to a fourth aspect, a computer program is provided, wherein the computer program comprises instructions which, when the program is executed by a computer, cause the computer to carry out the method as described above.

According to a fifth aspect, a computer-readable medium is provided, wherein the computer-readable medium comprises instructions which, when executed by a computer, cause the computer to carry out the method as described above.

According to a sixth aspect, a method for training a fill level classification model for determining fill level data of an elevator car is provided, wherein the method comprises: obtaining training input data comprising a plurality of images of the interior of at least one elevator car; classifying the plurality of images of the interior of the at least one elevator car into a plurality of predetermined fill level classes; and training the fill level classification model for determining the fill level data of the elevator car by using the training input data classified into the plurality of predetermined fill levels.

According to a seventh aspect, a computer program is provided, wherein the computer program comprises instructions which, when the program is executed by a computer, cause the computer to carry out the method for training a fill level classification model as described above.

According to an eighth aspect, a computer-readable medium is provided, wherein the computer-readable medium comprises instructions which, when executed by a computer, cause the computer to carry out the method for training a fill level classification model as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example implementation of a fill level determination system in the elevator system.

FIG. 3 illustrates schematically an example of a method for determining fill level data of an elevator car.

FIG. 4 illustrates schematically an example of an input-output process of a determination of fill level data of an elevator car by applying a pre-trained fill level classification model.

FIG. 5 illustrates schematically an example of a method for training of a fill level classification model.

FIG. 6 illustrates schematically an example of a determination of fill level data of an elevator car from obtained image data by applying the pre-trained fill level classification model.

FIG. 7 illustrates schematically an example of components of a computing unit of the fill level determination system.

FIG. 8 illustrates schematically an example of components of a computing entity.

### DESCRIPTION OF THE EXEMPLIFYING EMBODIMENTS

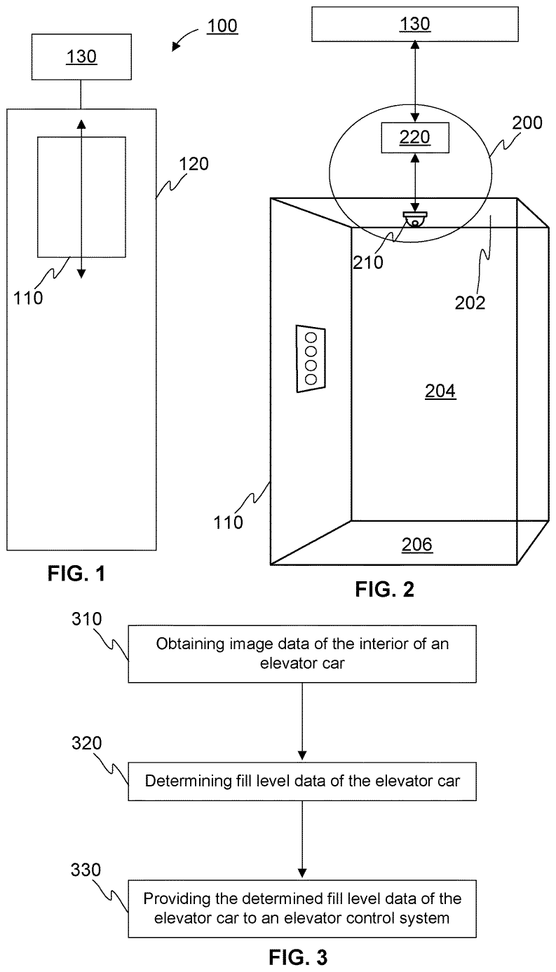

FIG. 1 illustrates schematically an example of an elevator system 100. The elevator system 100 comprises at least one elevator car 110 configured to travel along a respective elevator shaft 120 between a plurality of landings. The elevator system 100 of the example of FIG. 1 comprises one elevator car 110 travelling along one elevator shaft 120, however the elevator system 100 may also comprise an elevator group, i.e. group of two or more elevator cars 110 each travelling along a separate elevator shaft 120 configured to operate as a unit serving the same landings (for sake of clarity the plurality of landings are not illustrated in FIG. 1). The elevator system 100 further comprises an elevator control system, e.g. an elevator controller, 130. The elevator control system 130 is configured to control the operation of the elevator system 100 at least in part. The elevator control system 130 may reside e.g. in a machine room (for sake of clarity not shown in FIG. 1) or in one of the landings of the elevator system 100. The elevator system 100 may further comprise one or more other known elevator related entities, e.g. hoisting system, user interface devices, safety circuit and devices, elevator door system, etc., which are not shown in FIG. 1 for sake of clarity. The elevator system 100 further comprises a fill level determination system 200 for determining fill level data of an elevator car 110 (for sake of clarity entities of the fill level determination system 200 are not shown in FIG. 1). The fill level data of the elevator car 110 represents the fill level of the elevator car 110. The fill level of the elevator car 110 defines how full the elevator car 110 is.

FIG. 2 illustrates schematically an example implementation of the fill level determination system 200 in the elevator system 100. The fill level determination system 200 comprises an imaging device 210 and a computing unit 220. The imaging device 210 is communicatively coupled to the computing unit 220. The communication between the computing unit 220 and the imaging device 210 may be based on one or more known communication technologies, either wired or wireless.

The imaging device 210 is configured to produce image data of the interior of the elevator car 110. The imaging device 210 is arranged inside the elevator car 110. The imaging device 210 may be arranged (e.g. installed) at different installation positions (i.e. installation placements) inside the elevator car 110. This enables that the installation position of the imaging device 210 is not limited to one specific installation position (e.g. to the center of a ceiling 202). The imaging device 210 may preferably be placed in the vicinity of a ceiling 202 of the elevator car 110, i.e. as high as possible, as illustrated also in the example of FIG. 2. Some non-limiting example installation placements of the imaging device 210 may comprise: a wall placement, a corner placement, and a ceiling placement. In the wall placement, the imaging device 210 may be installed on a wall of the elevator car 110. The wall placement may for example be a back wall placement, wherein the imaging device 210 may be installed on the back wall 204 of the elevator car 110, preferably in the vicinity of the ceiling 202. Alternatively, the wall placement may be at any other wall of the elevator car 110, i.e. the imaging device 210 may be installed on any other wall of the elevator car 110, preferably in the vicinity of the ceiling 202. In the corner placement, the imaging device 210 may be installed in an upper corner of the elevator car 110. The corner placement may for example be at an upper back corner placement, wherein the imaging device 210 may be installed at the upper back corner of the elevator car 110. The upper back corner of the elevator car 110 may be either one the upper back corners of the elevator car 110. Alternatively, the corner placement may be at an upper front corner placement, wherein the imaging device 210 may be installed at the upper front corner of the elevator car 110. The upper front corner of the elevator car 110 may be either one the upper front corners of the elevator car 110. In the ceiling placement, the imaging device 210 may be installed on the ceiling 202 of the elevator car 110, as illustrated in the example of FIG. 2. The imaging device 210 may be installed so that the image data provided by the imaging device 210 covers as maximum area of the elevator car 110 as possible. Preferably, the imaging device 210 may be installed so that the image data provided by the imaging device 210 covers at least the floor 206 of the elevator car 110 completely. The imaging device 210 may for example be an optical imaging device configured to produce optical image data. The imaging device 210 may for example comprise a camera, e.g. a Red-Green-Blue (RGB) camera or a black-and-white camera. The imaging device 210 may be capable of providing the image data with a high resolution and/or a wide Field of View (FOV) to cover the maximum area of the elevator car 110 by the image data.

The computing unit 220 may be configured to control one or more operations of the fill level determination system 200 at least in part. The implementation of the computing unit 220 may be done as a stand-alone computing entity or as a distributed computing environment between a plurality of stand-alone computing entities, such as a plurality of servers, providing distributed computing resource. The computing unit 220 may be a local computing unit or a remote computing unit. Alternatively, the computing unit 220 may be implemented as a combined computing system comprising the local computing unit and the remote computing unit. The computing unit 220 implemented as the local computing unit may be arranged to the elevator car 110 (e.g. on a rooftop of the elevator car 110 or to any other location in the elevator car 110, either inside the elevator car 110 or outside the elevator car 110). Alternatively or in addition, the computing unit 220 implemented as the local computing unit may be arranged to any on-site location in the elevator system 100. According to an example, the computing unit 220 implemented as the local computing unit may be part of the elevator control system 130. The computing unit 220 implemented as the remote computing unit may be arranged to any off-site location being remote from the elevator system 100. The computing unit 220 implemented as the remote computing unit may for example comprise one or more computing entities located remotely from the elevator system 100. The computing unit 220 implemented as the remote computing unit may for example be, but is not limited to, at least one of the following: a cloud-based computing unit (e.g. a cloud server), a service center, a data center, a remote monitoring system, a remote diagnostic system or any other remote computing unit). The computing unit 220 may be communicatively coupled to the elevator control system 130 of the elevator system 100. The communication between the computing unit 220 and the elevator control system 130 may be based on one or more known communication technologies, either wired or wireless.

Next an example of a method for determining fill level data of an elevator car 110 is described by referring to FIG. 3. FIG. 3 schematically illustrates the method as a flow chart. The method is performed by the computing unit 220 of the fill level determination system 200 described above, i.e. the method may be a computer implemented method. The example method of FIG. 3 is described by using one elevator car 110, but if the elevator system 100 comprises two or more elevator cars 110, the method may also be applied correspondingly for determining fill level data of each elevator car 110 of the elevator system 100. If the elevator system 100 comprises two or more elevator cars 110 and the method is applied for determining the fill level data of more than one elevator car 110 of the elevator system 100, an imaging device 210 may be arranged inside each elevator car 110 for which the fill level data is to be determined and the computing unit 220 may be implemented as a common computing unit and/or as separate computing units for each elevator car 110 for which the fill level data is to be determined.

At a step 310, the computing unit 220 obtains image data 410 of the interior of the elevator car 110 from the imaging device 210. As discussed above, the imaging device 210 is configured to produce the image data 410 of the interior of the elevator car 110. The image data may for example be optical image data. The imaging device 210 is further configured to provide the produced image data 410 to the computing unit 220. Preferably, the imaging device 210 may provide the produced image data 410 to the computing unit 220 substantially immediately after producing the image data 410. The image data 410 produced by the imaging device 210 may for example comprise one or more images (i.e. frames) and/or video image comprising a plurality of consecutive images. According to an example, the imaging device 210 may produce the image data 410 of the interior of the elevator car 110 in response to receiving a control signal from the computing unit 220. The control signal may for example comprise an instruction to trigger the producing of the image data 410 of the interior of the elevator car 110. The generation of the control signal from the computing unit 220 to the imaging device 210 may for example be trigged by a sensor -based trigger event, a user input—based trigger event, and/or any other trigger event. According to another example, the imaging device 210 may produce the image data 410 from inside the interior of the elevator car 110 continuously and provide the produced image data 410 to the computing unit 220 continuously. According to yet another example, the imaging device 210 may produce the image data 410 from inside the interior of the elevator car 110 continuously and provide the produced image data 410 to the computing unit 220 in response to receiving from the computing unit 220 a control signal comprising an instruction to provide the image data 410 of the interior of the elevator car 110.

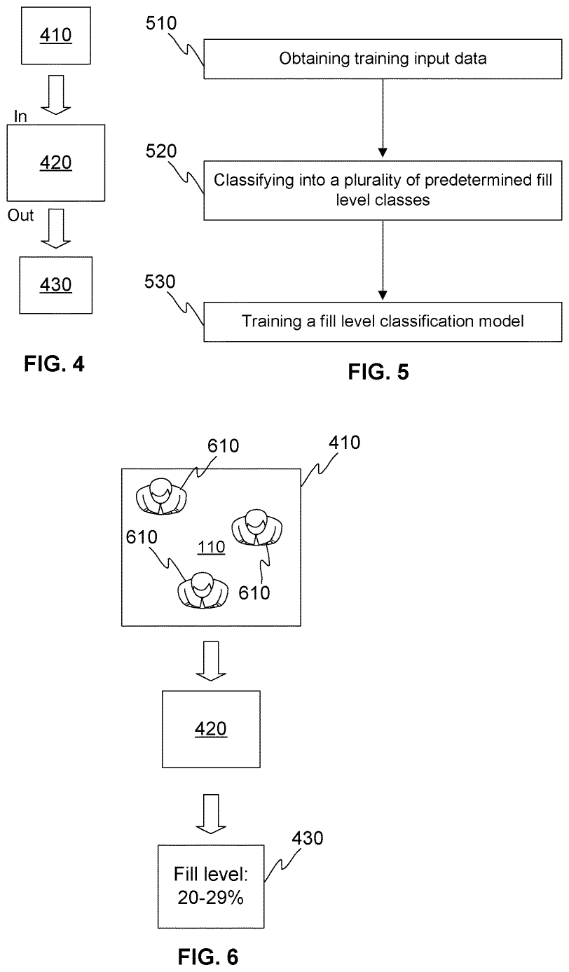

At a step 320, the computing unit 220 determines the fill level data 430 of the elevator car 110 from the obtained image data 410 by applying a pre-trained fill level classification model 420. In other words, at the step 320, the obtained image data 410 is used as input data of the pre-trained fill level classification model 420 and the input data 410 is processed with the pre-trained fill level classification model 420 to produce the determined fill level data 430 as the output data of the pre-trained fill level classification model 420. FIG. 4 illustrates schematically an example of the input-output process of the determination of the fill level data 430 of the elevator car 110 from the obtained image data 410 by applying the pre-trained fill level classification model 420. The pre-trained fill level classification model 420 may be a neural network -based model, e.g. a convolutional neural network (CNN) -based model. A non-limiting example of the CNN -based model may be MobileNet V3. However, any other neural network-based models may also be used. The type of neural network may have an effect on the accuracy of the determined fill level data 430 of the elevator car 110. Thus, the accuracy of the determined fill level data 430 of the elevator car 110 may be optimized (e.g. increased) by selecting a neural network type resulting in a high accuracy. Training of the pre-trained fill level classification model 420 will be described more later in this application.

At a step 330, the computing unit 220 provides the determined fill level data 430 of the elevator car 110 to the elevator control system 130 for further elevator use. The further elevator use may for example comprise elevator call allocation and/or presentation of information. For example, in the elevator car allocation use of the determined fill level data 430 of the elevator car 110, further landing calls are not allocated for the elevator car 110, if the determined fill level data 430 indicates that the elevator car 110 is full. In other words, the elevator car 110 that is determined, by the elevator control system 130, to be full based on the determined fill level data 430 received from the computing unit 220 of the fill level determination system 200 bypasses the landing(s) between a departure landing and a destination landing, regardless of whether a landing call is generated from the bypassed landing(s). The use of the determined fill level data 430 in the elevator car allocation improves the elevator car allocation process. For example, in the presentation of information use of the determined fill level data 430, the determined fill level data 430 may be displayed on one or more displays. The one or more displays may for example comprise at least one elevator lobby screen and/or at least one building manager interfaces. Displaying the determined fill level data 430 on the one or more displays enables that the users (e.g. passengers) of the elevator system 100 and/or building manager may receive information about the fill level of the one or more elevator cars of the elevator system 100. The determined fill level data 430 displayed on the one or more displays may for example comprise the determined fill level data 430 in percentages and/or as a schematic image generated based on the determined fill level data 430. Alternatively or in addition, the obtained image data 410 may be displayed on the one or more displays. This enables that the users (e.g. passengers) of the elevator system 100 and/or building manager may receive yet further information about the fill level of the one or more elevator cars of the elevator system 100.

As already the name “pre-trained fill level classification model” indicates, the fill level classification model 420 is trained before it can be used for the determination of the fill level data 430 of the elevator car 110. Next an example of a method for training of the fill level classification model 420 (i.e. a training method) is described by referring to FIG. 5. FIG. 5 schematically illustrates the training method as a flow chart. The pre-trained fill level classification model 420 used for determining the fill level data 430 of the elevator car 110 represents the fill level classification model 420 trained by using the training method. The training of the fill level classification model 420 may comprise at least pre-training (i.e. the training of the fill level classification model 420 before the use of the pre-trained fill level classification model 420 for the determination of the fill level data 430 of the elevator car 110). The training of the fill level classification model 420 may further comprise continuous training (i.e. training and/or refining of the pre-trained fill level classification model 420 during the use of said model 420 for the determination of the fill level data 430 of the elevator car 110). Both the pre-training and the continuous training may be performed by using the example training method of FIG. 5.

At a step 510, a computing entity 800 obtains training input data comprising a plurality of images of the interior of at least one elevator car. The training input data may for example be optical image data comprising a plurality of optical images of the interior of the at least one elevator car. The computing entity 800 may be the computing unit 220 of the fill level determination system 200. Alternatively, the computing entity may be an external computing entity being external to the fill level determination system 200. The computing unit 220 may be communicatively coupled to the computing entity 800. The communication between the computing unit 220 and the computing entity 800 may be based on one or more known communication technologies, either wired or wireless. Preferably, the training input data comprises a large number of images of the interior of the at least one elevator car. The training input data may comprise a plurality of images of the interior of the same elevator car 110 for which the fill level will be determined by using the pre-trained fill level classification model 420. The training input data comprising the plurality of images of the interior of the same elevator car 110 may for example be produced by the imaging device 210 of the fill level determination system 200 arranged inside said elevator car 110. Alternatively or in addition, the training input data may comprise a plurality of images of the interior of one or more other substantially similar elevator cars. The training input data comprising the plurality of images of the interior of the one or more other substantially similar elevator cars may for example be produced by one or more imaging devices arranged inside the one or more other substantially similar elevator cars. Alternatively or in addition, the training input data may comprise a plurality of images of the interior of one or more elevator car generated by using one or more artificial intelligence (AI)-based image generators. The training of the fill level classification model 420 by using the training input data comprising the plurality of images of the interior of the same elevator car 110 for which the fill level will be determined by using the pre-trained fill level classification model 420 improves the accuracy of the determined fill level data 430 of the elevator car 110 in question. For example, the obtained image data 410 used for determining the fill level data 430 by applying the pre-trained fill level classification model 420 may be used alone or together with the determined fill level data 430 in the continuous training of the pre-trained fill level classification model 420. While the training of the fill level classification model 420 by using the training input data comprising the plurality of images of the interior of one or more other substantially similar elevator cars enables producing a universally functional fill level classification model 420 that may be used for determining fill level data of multiple substantially similar elevator cars with a sufficient accuracy.

The fill level data 430 of the elevator car 110 may be determined by applying the pre-trained fill level classification model 420 by taking into account only human objects (e.g. passengers) inside the elevator car 110. Alternatively, the fill level data 430 of the elevator car 110 may be determined by applying the pre-trained fill level classification model 420 by taking into account both the human objects and non-human objects (e.g. luggage, wheelchair, and/or goods, etc.) inside the elevator car 110. If only the human objects are taken into account in the determination of the fill level data 430 of the elevator car 110, the training input data may comprise a plurality images of the interior of the at least one elevator car where only human objects are inside the elevator car. If both the human objects and the non-human objects are taken into account in the determination of the fill level data 430 of the elevator car 110, the training input data may comprise a plurality of images of the interior of the at least one elevator car where human objects and/or non-human objects are inside the elevator car. Taking into account only human objects may enable a simpler pre-trained fill level classification model 420, and/or faster and easier training of the fill level classification model 420. Also, the size of the model 420 may be reduced and the determination speed of the model 420 may be increased, if only human objects are taken into account. Taking into account both the human objects and the non-human objects the accuracy of the determined fill level data 430 may be improved.

At a step 520, the plurality of images of the interior of the at least one elevator car comprised in the training input data are classified into a plurality of predetermined fill level classes. Each fill level class represents different fill level of the elevator car 110. The different fill levels of the elevator car 110 may be expressed as a percentage, wherein 0 % fill level represents an empty elevator car 110 and 100 % fill level represents a full elevator car 110. According to a non-limiting example, the plurality of predetermined fill level classes may comprise 10 fill level classes. These 10 example fill level classes may for example comprise the following fill level classes: class 1: 0-9 % fill level, class 2: 10-19 % fill level, class 3: 20-29 % fill level, class 4: 30-39 % fill level, class 5: 40-49 % fill level, class 6: 50-59 % fill level, class 7: 60-69 % fill level, class 8: 70-79 % fill level, class 9: 80-89 % fill level, and class 10: 90-100% fill level. This is only one non-limiting example of the plurality of predetermined fill level classes, and the plurality of predetermined fill level classes may comprise any other number of fill level classes having any other distribution of the fill levels. Each image belonging to the plurality of images comprised in the generated training input data are associated with label data indicating the fill level class into which said image is classified. The plurality of images associated with the label data are used to train the fill level classification model 420 at a step 530 (as will described later in this application) so that the pre-trained fill level classification model 420 may be used for determining from the image data 410 of the interior of the elevator car 110 the fill level class that corresponds to the fill level of the elevator car 110 in said image data 410. The label data may further indicate the presence of human objects and/or non-human objects inside the elevator car in the respective image, i.e. whether human objects and/or non-human objects are inside the elevator car in the respective image. In addition to the classification, one or more known pre-processing operations (e.g. sampling, transformation, denoising, etc.) for the training input data may be performed.

At the step 530, the computing entity 800 trains the fill level classification model 420 by using the training input data classified into the plurality of predetermined fill level classes to produce the pre-trained fill level classification model 420 used for determining the fill level data 430 of the elevator car 110. If the computing entity 800 is the external computing entity, the computing entity 800 provides the pre-trained fill level classification model 420 to the computing unit 220. The training step 530 may comprise one or more known training phases (e.g. initial training, validation, testing, etc.). After the fill level classification model 420 has been trained, the computing unit 220 is able to determine from the obtained image data 410 by applying the pre-trained fill level classification model 420 the fill level class that corresponds to the fill level of the elevator car 110 in the obtained image data. In other words, the determining of the fill level data 430 of the elevator car 110 at the step 320 may comprise determining from the obtained image data 410 by applying the pre-trained fill level classification model 420 the fill level class (that belongs to the plurality of predetermined fill level classes) that corresponds to the fill level of the elevator car 110 in the obtained image data.

The determined fill level data 430 of the elevator car 110 may comprise data indicating the determined fill level class. For example, the determined fill level data 430 of the elevator car 110 may comprise the determined fill level class and/or the fill level of the elevator car 110 represented by the determined fill level class. FIG. 6 illustrates schematically a non-limiting example of the determination of the fill level data 430 of the elevator car 110 from the obtained image data 410 by applying the pre-trained fill level classification model 420. In the example of FIG. 6, it is assumed that the plurality of predetermined fill level classes comprises the same ten predetermined fill level classes as discussed in the above non-limiting example. The image data 410 of the interior of the elevator car 110 indicates that three human objects (e.g. passengers) 610 are inside the elevator car 110. The computing unit 220 applies the pre-trained fill level classification mode 420 to determine from the obtained image data 410 the fill level class that corresponds to the fill level of the elevator car 110 in the obtained image data 410. In the non-limiting example of FIG. 6, it is assumed that the fill level class corresponding to the fill level of the elevator car 110 in the obtained image data 410 is the fill level class 3: 20-29% fill level, which indicates that the elevator car 110 is 20-29 % full. Thus, the determined fill level data 430 may comprise data indicating that the fill level is 20-29 %. In other words, in this example, the determined fill level data 430 may indicate that the elevator car 110 is 20-29 % full.

The image analysis-based elevator car fill level determination solution according to the method and the fill level determination system 200 described above enables determination of the fill level of the elevator car 110 without a need for a calibration, which is a clear advantage in comparison to the traditional image analysis-based elevator car fill level determination solutions discussed for example in the background section, in which the calibration is required. Furthermore, in the image analysis-based elevator car fill level determination solution according to the method and the fill level determination system 200 described above there is no limitation on the shape of the elevator car 110, the size of the elevator car 110, the material and color of the walls of the elevator car 110, and the lighting inside the elevator car 110. Thus, the accuracy of the elevator car fill level determination solution is increased. Furthermore, the elevator car fill level determination solution may be widely used in different kind of elevator cars.

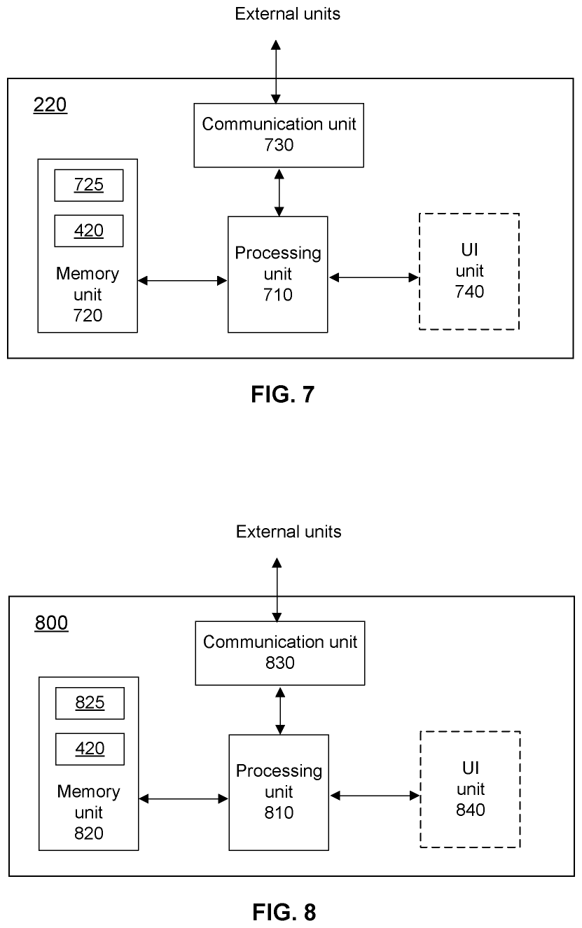

FIG. 7 illustrates schematically an example of components of the computing unit 220 of the fill level determination system 200. The computing unit 220 may comprise a processing unit 710 comprising one or more processors, a memory unit 720 comprising one or more memories, a communication interface unit 730 comprising one or more communication devices, and possibly a user interface (UI) unit 740. The mentioned elements may be communicatively coupled to each other with e.g. an internal bus. The memory unit 720 may store and maintain portions of a computer program (code) 725, the pre-trained fill level classification model 420, the obtained image data 410, the determined fill level data 430, and any other data. The computer program 725 may comprise instructions which, when the computer program 725 is executed by the processing unit 710 of the computing unit 220 may cause the processing unit 710, and thus the computing unit 220 to carry out desired tasks, e.g. one or more of the method steps described above and/or the operations of the computing unit 220 described above. The processing unit 710 may thus be arranged to access the memory unit 720 and retrieve and store any information therefrom and thereto. For sake of clarity, the processor herein refers to any unit suitable for processing information and control the operation of the computing unit 220, among other tasks. The operations may also be implemented with a microcontroller solution with embedded software. Similarly, the memory unit 720 is not limited to a certain type of memory only, but any memory type suitable for storing the described pieces of information may be applied in the context of the present invention. The communication interface unit 730 provides one or more communication interfaces for communication with any other unit, e.g. the imaging device 210, the elevator control system 130, the computing entity 800, one or more databases, and/or with any other unit. The user interface unit 740 may comprise one or more input/output (I/O) devices, such as buttons, keyboard, touch screen, microphone, loudspeaker, display and so on, for receiving user input and outputting information. The computer program 725 may be a computer program product that may be comprised in a tangible nonvolatile (non-transitory) computer-readable medium bearing the computer program code 725 embodied therein for use with a computer, i.e. the computing unit 220.

FIG. 8 illustrates schematically an example of components of the computing entity 800 used for performing the training of the fill level classification model 420. The computing entity 800 may comprise a processing unit 810 comprising one or more processors, a memory unit 820 comprising one or more memories, a communication interface unit 830 comprising one or more communication devices, and possibly a user interface (UI) unit 840. The mentioned elements may be communicatively coupled to each other with e.g. an internal bus. The memory unit 820 may store and maintain portions of a computer program (code) 825, the pre-trained fill level classification model 420, the training input data, and any other data. The computer program 825 may comprise instructions which, when the computer program 825 is executed by the processing unit 810 of the computing entity 800 may cause the processing unit 810, and thus the computing entity 800 to carry out desired tasks, e.g. one or more of the method steps described above and/or the operations of the computing entity 800 described above. The processing unit 810 may thus be arranged to access the memory unit 820 and retrieve and store any information therefrom and thereto. For sake of clarity, the processor herein refers to any unit suitable for processing information and control the operation of the computing entity 800, among other tasks. The operations may also be implemented with a microcontroller solution with embedded software. Similarly, the memory unit 820 is not limited to a certain type of memory only, but any memory type suitable for storing the described pieces of information may be applied in the context of the present invention. The communication interface unit 830 provides one or more communication interfaces for communication with any other unit, e.g. the communication unit 220, the imaging device 210, one or more other imaging devices, the elevator control system 130, one or more databases, and/or with any other unit. The user interface unit 840 may comprise one or more input/output (I/O) devices, such as buttons, keyboard, touch screen, microphone, loudspeaker, display and so on, for receiving user input and outputting information. The computer program 825 may be a computer program product that may be comprised in a tangible nonvolatile (non-transitory) computer-readable medium bearing the computer program code 825 embodied therein for use with a computer, i.e. the computing entity 800.

The specific examples provided in the description given above should not be construed as limiting the applicability and/or the interpretation of the appended claims. Lists and groups of examples provided in the description given above are not exhaustive unless otherwise explicitly stated.

1. A method for determining fill level data of an elevator car, wherein the method comprises:
obtaining image data of the interior of the elevator car;
determining the fill level data of the elevator car from the obtained image data by applying a pre-trained fill level classification model; and
providing the determined fill level data of the elevator car to an elevator control system for further elevator use.

2. The method according to claim 1, wherein the determining of the fill level data of the elevator car comprises determining from the obtained image data by applying the pre-trained fill level classification model a fill level class belonging to a plurality of predetermined fill level classes that corresponds to the fill level of the elevator car in the obtained image data.

3. The method according to claim 2, wherein the determined fill level data of the elevator car comprises data indicating the determined fill level class.

4. The method according to claim 1, wherein the further elevator use comprises elevator call allocation and/or presentation of information.

5. The method according to claim 1, wherein the pre-trained fill level classification model is a convolutional neural network (CNN)-based model.

6. A fill level determination system for determining fill level data of an elevator car, wherein the fill level determination system comprises:
an imaging device arranged inside the elevator car and configured to produce image data of the interior of the elevator car, and
a computing unit configured to:
obtain the image data of the interior of the elevator car from the imaging device;
determine the fill level data of the elevator car from the obtained image data by applying a pre-trained fill level classification model; and
provide the determined fill level data of the elevator car to an elevator control system for further elevator use.

7. The fill level determination system according to claim 6, wherein the determination of the fill level data of the elevator car comprises that the computing unit is configured to determine from the obtained image data by applying the pre-trained fill level classification model a fill level class belonging to a plurality of predetermined fill level classes that corresponds to the fill level of the elevator car in the obtained image data.

8. The fill level determination system according to claim 7, wherein the determined the fill level data of the elevator car comprises data indicating the determined fill level class.

9. The fill level determination system according to claim 6, wherein the further elevator use comprises elevator call allocation and/or presentation of information.

10. The fill level determination system according claim 6, wherein the pre-trained fill level classification model is a convolutional neural network (CNN)-based model.

11. An elevator system, comprising:
at least one elevator car arranged to travel along a respective elevator shaft,
an elevator control system configured to control the operation of the elevator system; and
a fill level determination system according to claim 6.

12. A non-transitory computer-readable medium storing a computer program comprising instructions which, when the program is executed by a computer, cause the computer to carry out the method according to claim 1.

13. A non-transitory computer-readable medium storing a computer program comprising instructions which, when executed by a computer, cause the computer to carry out the method according to claim 2.

14. A method for training a fill level classification model for determining fill level data of an elevator car, the method comprises:
obtaining training input data comprising a plurality of images of the interior of at least one elevator car;
classifying the plurality of images of the interior of the at least one elevator car into a plurality of predetermined fill level classes; and
training the fill level classification model for determining the fill level data of the elevator car by using the training input data classified into the plurality of predetermined fill levels.

15. A non-transitory computer-readable medium storing a computer program comprising instructions which, when the program is executed by a computer, cause the computer to carry out the method according to claim 14.

16. A non-transitory computer-readable medium storing a computer program comprising instructions which, when executed by a computer, cause the computer to carry out the method according to claim 14.

17. The method according to claim 2, wherein the further elevator use comprises elevator call allocation and/or presentation of information.

18. The method according to claim 3, wherein the further elevator use comprises elevator call allocation and/or presentation of information.

19. The method according to claim 2, wherein the pre-trained fill level classification model is a convolutional neural network (CNN)-based model.

20. The method according to claim 3, wherein the pre-trained fill level classification model is a convolutional neural network (CNN)-based model.
